(19) United States
(12) Patent Application Publication
(10) Pub. No.: US 2015/0054724 A1
(43) Pub. Date: Feb. 26, 2015

(54) LIQUID CRYSTAL DEVICE AND DISPLAY DEVICE

(71) Applicant: CENTURY TECHNOLOGH (SHENZHEN) CORPORATION LIMITED, SHENZHEN (CN)

(72) Inventors: MING-TSUNG WANG, New Taipei (TW); KUO-CHIEH CHI, New Taipei (TW); DAN CHEN, Shenzhen (CN); QI XU, Shenzhen (CN)

(73) Assignee: CENTURY TECHNOLOGH (SHENZHEN) CORPORATION LIMITED, SHENZHEN (CN)

(21) Appl. No.: 14/140,580

(22) Filed: Dec. 26, 2013

(30) Foreign Application Priority Data
Aug. 23, 2013 (CN) 2013103718847

(51) Int. Cl. G09G 3/36

(52) U.S. Cl. CPC G09G 3/3648
USPC 345/98

(57) ABSTRACT

A display device includes a common electrode receiving a common voltage, a display media layer, and a substrate. The substrate defines a display area and a border area surrounding the display area. The display area includes a plurality of pixel electrodes and a plurality of signal lines. The pixel electrodes receive data voltages. The media layer displays images based on the data voltages and the common voltage. The signal lines transmit signals. The border area includes a common electrode line and at least one electrostatic discharge component. The common electrode line is connected to the common electrode and transmits the common voltage to the common electrode. Each electrostatic discharge component is connected between a signal line and the common electrode line.

### BACKGROUND

1. Technical Field

The present disclosure relates a display technology, and particularly to, a liquid crystal display device and a display device.

2. Description of Related Art

A floating line is usually positioned at a peripheral non-transparent area of a display device. The floating line is connected to signal lines via electrostatic discharge components. Accordingly, when high voltage electrostatic discharges occur on the signal lines, the high voltage electrostatic discharges are discharged to a periphery of an interior of the display device via the electrostatic discharge components and the floating line.

However, because the floating line is positioned at the peripheral non-transparent area of the display device, a size of the peripheral non-transparent area is increased, resulting in an adverse development to a narrow frame of the display device.

Therefore, what is needed is a liquid crystal display device and a display device that can overcome the described limitations.

### BRIEF DESCRIPTION OF THE DRAWINGS

FIG. 1 is an isometric view of a first embodiment of a display device.

FIG. 2 is an exploded, isometric view of the display device of FIG. 1.

FIG. 3 is a circuit diagram of the display device of FIG. 1.

FIG. 4 is a circuit diagram of a second embodiment of a display device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Reference will now be made to the drawings to describe embodiments of the present disclosure.

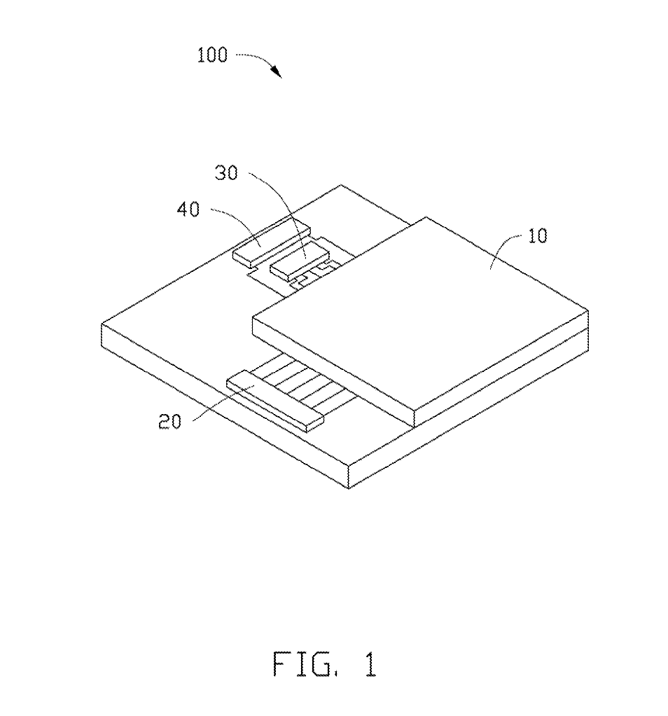

FIG. 1 illustrates a first embodiment of a display device 100. In one embodiment, the display device 100 is a liquid crystal display device. The display device 100 comprises a display panel 10, a gate driver 20, a data driver 30, and a common voltage generating circuit 40. The display panel 10 is connected to the gate driver 20, the data driver 30, and the common voltage generating circuit 40.

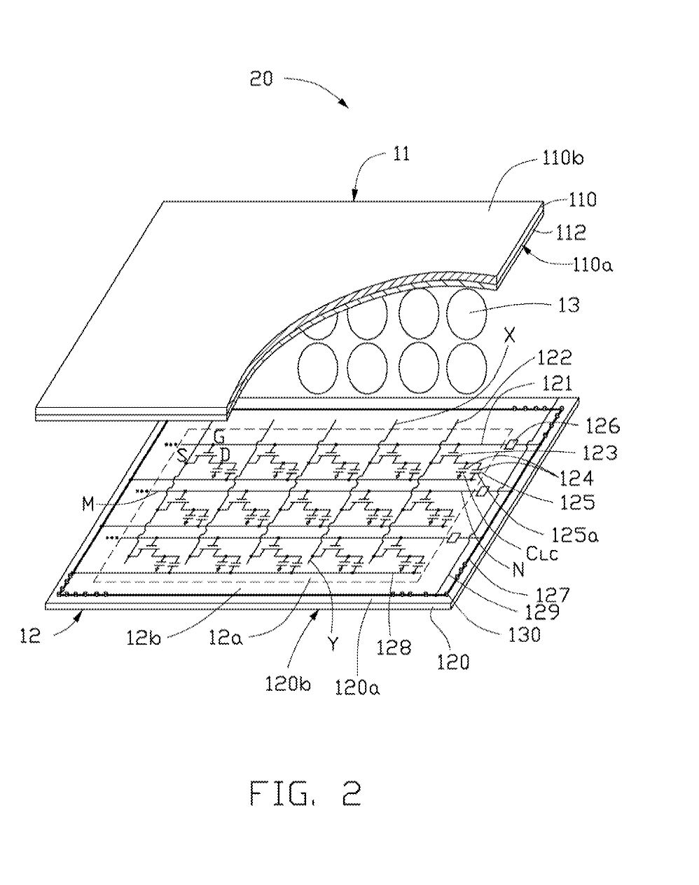

FIG. 2 is an exploded, isometric view of the display device 100. The display panel 10 comprises a color filter (CF) substrate 11, a thin film transistor (TFT) substrate 12 opposing the CF substrate 11, and a display media layer 13 located between the CF substrate 11 and the TFT substrate 12. In one embodiment, the display media layer 13 is a liquid crystal layer.

The CF substrate 11 comprises a substrate 110 and a common electrode 112. The substrate 110 comprises a first side 110a facing the display media layer 13 and a second side 110b opposing the first side 110a. The common electrode 112 is located on the first side 110a of the substrate 110.

The TFT substrate 12 comprises a substrate 120, a plurality of gate lines 121, a plurality of data lines 122, a plurality of TFTs 123, a plurality of pixel electrodes 124, a plurality of storage capacitors 125, and at least one electrostatic discharge component 126, a common electrode line 127, a plurality of storage capacitor lines 128, a feedback line 129, and silver paste 130. The substrate 120 comprises a first side 120a facing the display media layer 13 and a second side 120b opposing the first side 120a. The gate lines 121, the data lines 122, the TFTs 123, the pixel electrodes 124, the storage capacitors 125, the at least one electrostatic discharge component 126, the common electrode line 127, the storage capacitor lines 128, the feedback line 129, and the silver paste 130 are located on the first side 120a of the substrate 12. Each TFT 123 comprises a gate electrode G, a source electrode S, and a drain electrode D. Each gate line 121 comprises a first end M and a second end N. Each data line 122 comprises a first end X and a second end Y.

The substrate 120 defines a display area 12a and a border area 12b surrounding the display area 12a. The display area 12a transmits light, and is configured to display images. The border area 12b does not transmit light, and is configured for the arrangement of wires and electronic components.

The gate lines 121 extends from a side of the border area 12b to another side of the border area 12b via the display area 12a. The data lines 122 extends from the border area 12b to the display area 12a, and intersects the gates lines 121. The TFTs 123, the pixel electrodes 124, and the storage capacitors 125 are located at the display area 12a. The TFTs 123 are respectively located at intersections cooperatively defined by the gate lines 121 and the data lines 122. The gate electrode G of each TFT 123 is connected to a gate line 121. The source electrode S of each TFT 123 is connected to a data line 122. The drain electrode D of each TFT 123 is connected to a pixel electrode 124.

Each storage capacitor 125 comprises a storage capacitor electrode 125a and an insulating layer (not labeled) located between the pixel electrode 124 and the storage capacitor electrode 125a. The storage capacitor lines 128 are substantially parallel with the gate lines 121, and are connected to the storage capacitor electrodes 125a. The pixel electrodes 124, the display media layer 13, and the common electrode 112 forms a plurality of display capacitors C_{LC}. The display capacitors C_{LC} are located at the display area 12a.

The common electrode line 127, the at least one electrostatic discharge component 126, the feedback line 129, and the silver paste 130 are located at the border area 12b. In one embodiment, the number of the at least one electrostatic discharge component 126 is identical with the number of the gate lines 121. However, in other embodiments, the number of the at least one electrostatic discharge component 126 can also differ from the number of the gate lines 121. The common electrode line 127 is located at the border area 12b and surrounds the display area 12a.

Each storage capacitor line 128 is connected to a side of the common electrode line 127 adjacent to the first ends M of the gate lines 121 and extends along a direction substantially parallel to the gate lines 121. The second end N of each gate line 121 is connected to the common line 127 via the electrostatic discharge component 126. The feedback line 129 is substantially parallel with the data line 122 and is connected to the common electrode line 127. The silver paste 130 is located on the common electrode line 127, and connects the common electrode line 127 to the common electrode 112.

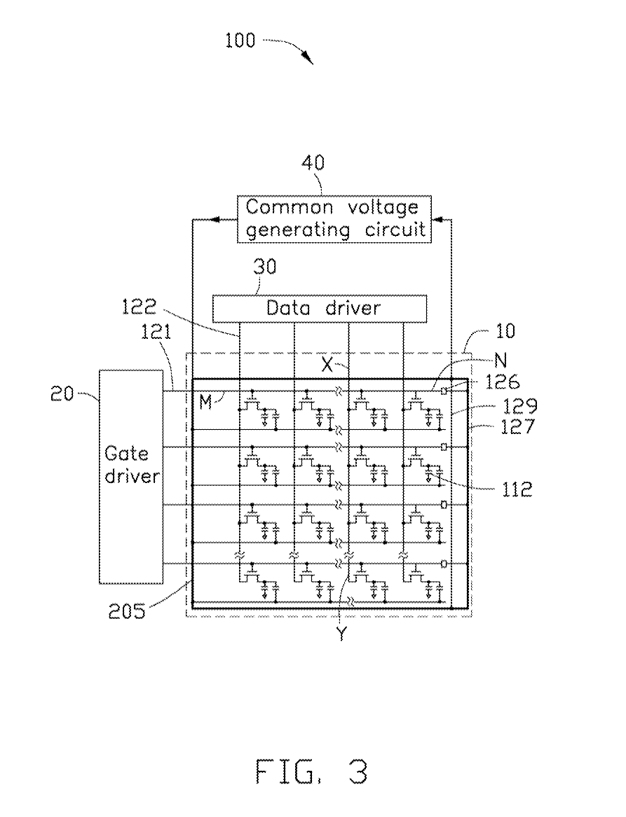

Referring to FIGS. 2 and 3, FIG. 3 is a circuit diagram of the display device 100. The gate driver 20 is connected to the first ends M of the gate lines 121, and outputs gate signals to the TFTs 123 via the gate lines 121. The gate signals are transmitted from the first ends M of the gate lines 121 to the second ends N of the gate lines 121. The TFTs 123 are switched on based on the gate signals. The data driver 30 is connected to the first ends X of the data lines 122, and outputs data voltages to the pixel electrodes 124 via the source electrodes S and the drain electrodes D of the TFTs 123. The common voltage generating circuit 40 is connected to the common electrode line 127 and outputs a common voltage to the storage capacitors 125 and the common electrode 112 via the common electrode line 127. The display panel 10 displays images based on the data voltages and the common voltage. The common voltage generating circuit 40 is further connected to the feedback line 129. The feedback line 129 receives a feedback common voltage from the common electrode line 127 and outputs the feedback common voltage to the common voltage generating circuit 40. The common voltage generating circuit 40 further receives the feedback common voltage and adjusts the common voltage output to the common electrode line 127 based on the feedback common voltage, so as to maintain a stability of the common voltage applied to the common electrode 112.

When high voltage electrostatic discharges occur on one or more gate lines 121, the high voltage electrostatic discharges are transmitted to the common electrode line 127 via the one or more gate lines 121 and the one or more electrostatic discharge components 126 connected to the one or more gate lines 121, so as to protect the display device 100.

Since the high voltage electrostatic discharges are discharged via the electrostatic discharge components 126 and the common electrode line 127 are connected to the electrostatic discharge components 126, it is unnecessary to lay an extra floating line on the border area 12b to discharge the high voltage electrostatic discharges. Accordingly, the border area 12 is relatively narrow.

In addition, since the common voltage transmitted by the common electrode line 127 is applied to the common electrode 112, the images displayed by the display device 100 are not affected by the high voltage electrostatic discharges.

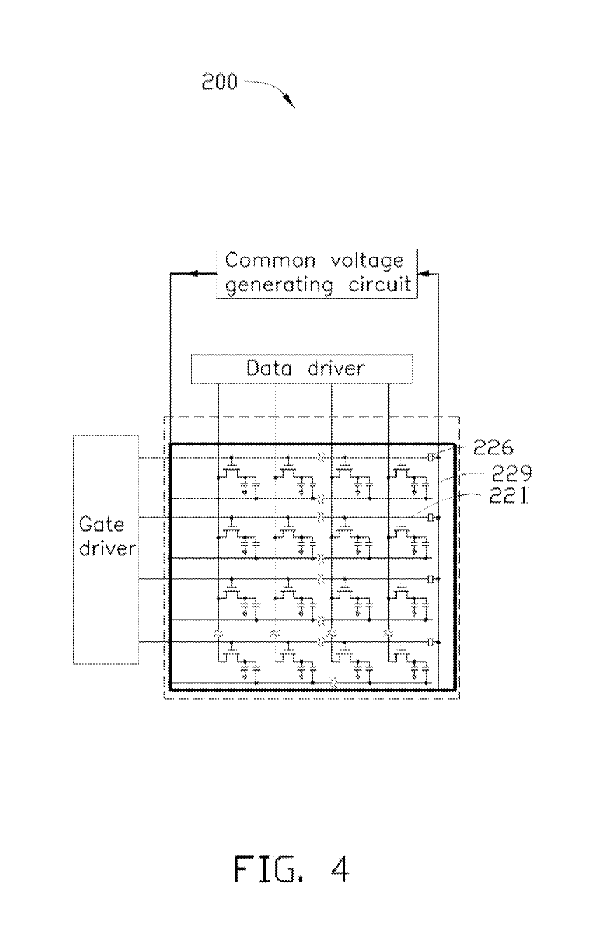

FIG. 4 is a circuit diagram of a second embodiment of a display device 200. The second embodiment of the display device 200 differs from the first embodiment of the display device 100 in that each gate line 221 is connected to a feedback line 229 via an electrostatic discharge component 226.

When the high voltage electrostatic discharges occur on one or more gate lines 221, the high voltage electrostatic discharges are transmitted to the feedback line 229 via the one or more gate lines 221 and the one or more electrostatic discharge components 226 connected to the one or more gate lines 221, so as to protect the display device 200.

Because the feedback line 229 is an inherent line of the display device 200, there is no need to lay an extra floating line on the border area (not labeled) to discharge the high voltage electrostatic discharges. Accordingly, the border area of the display device 200 is relatively narrow.

In alternative embodiments, besides the gate lines 100, 200, other signal lines, such as data lines 122, 222, can also be respectively connected to the common electrode lines 127, 227 via the electrostatic discharge components 126, 226, or directly connected to the feedback lines 129, 229.

The display devices 100, 200, can also be an in-plane switching (IPS) type liquid crystal display device, fringe field switching type liquid crystal display device, or other appropriate display devices.

It is believed that the present embodiments and their advantages will be understood from the foregoing description, and it will be apparent that various changes may be made thereto without departing from the spirit and scope of the present disclosure or sacrificing all of its material advantages.

What is claimed is:

1. A display device, comprising a common electrode receiving a common voltage, a display media layer, and a substrate defining a display area transmitting light and a border area not transmitting light and surrounding the display area, wherein the display area comprises a plurality of pixel electrodes receiving data voltages and a plurality of signal lines transmitting signals, the media layer displays images based on the data voltages and the common voltage, the border area comprises at least one electrostatic discharge component and a common electrode line connected to the common electrode and transmitting the common voltage to the common electrode, and the at least one electrostatic discharge component is connected between a signal line and the common electrode line.

2. The display device of claim 1, wherein the at least one electrostatic discharge component is directly connected to the common electrode line.

3. The display device of claim 2, wherein the border area comprises a plurality of electrostatic discharge components, and each signal line is connected to the common electrode line via the at least one electrostatic discharge component.

4. The display device of claim 2, wherein the display area further comprises a plurality of transistors and a plurality of pixel electrodes; the signal lines comprises a plurality of gate lines and a plurality of data lines; each transistor comprises a gate electrode, a source electrode, and a drain electrode; the gate lines are connected to the gate electrodes of the transistors and transmit gate signals to the gate electrodes; the pixel electrodes are connected to the drain electrodes of the transistors; the data lines are connected to the source electrodes of the transistors and transmit the data voltages to the pixel electrodes via the transistors; the transistors are switched on based on the transistors receiving the gate signals.

5. The display device of claim 4, wherein the at least one electrostatic discharge component comprises a plurality of electrostatic discharge components located in the border area, and each gate line is connected to the common electrode line via the at least one electrostatic discharge component.

6. The display device of claim 5, further comprising a gate driver; wherein each gate line comprises a first end and a second end; the gate driver is connected to the first ends of the gate lines and outputs the gate signals to the gate lines; the gate signals are transmitted from the first ends to the second ends; the electrostatic discharge components are connected to the second ends of the gate lines.

7. The display device of claim 6, wherein the display device is a liquid crystal display device.

8. The display device of claim 6, further comprising a common voltage generating circuit and a feedback line connected to the common voltage generating circuit and the common electrode line; wherein the common voltage generating circuit outputs the common voltage to the common electrode via the common electrode line; the feedback line is located on the border area adjacent to the second ends of the gate lines, the feedback line receives a feedback common voltage from the common electrode line and outputs the feedback common voltage to the common voltage generating circuit; the common voltage generating circuit adjusts the common voltage output to the common electrode line based on the feedback common voltage.

9. A display device, comprising a common electrode receiving a common voltage, a display media layer, and a substrate defining a display area transmitting light and a border area not transmitting light and surrounding the display area, wherein the display area comprises a plurality of pixel electrodes receiving data voltages and a plurality of signal lines transmitting signals, the media layer displays images based on the data voltages and the common voltage, the border area comprises at least one electrostatic discharge component, a common electrode line connected to the common electrode and transmitting the common voltage to the common electrode, a common voltage generating circuit generating the common voltage and outputting the common voltage to the common electrode via the common electrode line, and a feedback line connected to the common electrode line and the common voltage generating circuit, receiving a feedback common voltage from the common electrode line, and outputting the feedback voltage to the common voltage generating circuit, the common voltage generating circuit further adjusts the common voltage output to the common electrode line based on the feedback common voltage, and the at least one electrostatic discharge component is connected between a signal line and the feedback line.

10. The display device of claim 9, wherein the at least one electrostatic discharge component is directly connected to the feedback line.

11. The display device of claim 10, wherein the border area comprises a plurality of electrostatic discharge components, and each signal line is connected to the feedback line via the at least one electrostatic discharge component.

12. The display device of claim 10, wherein the display area further comprises a plurality of transistors and a plurality of pixel electrodes; the signal lines comprises a plurality of gate lines and a plurality of data lines; each transistor comprises a gate electrode, a source electrode, and a drain electrode; the gate lines are connected to the gate electrodes of the transistors and transmit gate signals to the gate electrodes; the pixel electrodes are connected to the drain electrodes of the transistors; the data lines are connected to the source electrodes of the transistors and transmit the data voltages to the pixel electrodes via the transistors; the transistors are switched on based on the transistors receiving the gate signals.

13. The display device of claim 12, wherein the at least one electrostatic discharge component comprises a plurality of electrostatic discharge components located in the border area, and each gate line is connected to the common electrode line via the at least one electrostatic discharge component.

14. The display device of claim 13, further comprising a gate driver; wherein each gate line comprises a first end and a second end; the gate driver is connected to the first ends of the gate lines and outputs the gate signals to the gate lines; the gate signals are transmitted from the first ends to the second ends; the electrostatic discharge components are connected to the second ends of the gate lines.

15. The display device of claim 14, wherein the display device is a liquid crystal display device.

16. A liquid crystal display device, comprising a common electrode receiving a common voltage, a liquid crystal layer, and a substrate defining a display area transmitting light and a border area not transmitting light and surrounding the display area;
the display area comprising:
a plurality of transistors, each transistor comprising a gate electrode, a source electrode, and a drain electrode;
a plurality of gate lines connected to the transistors and transmitting gate signals to the gate electrodes of the transistors, wherein whether the transistors are switched on based on whether the transistors receive the gate signals;
a plurality of pixel electrodes connected to the drain electrodes of the transistors; and
a plurality of data lines connected to the source electrodes of the transistors and transmitting data voltages to the pixel electrodes via the transistors, such that the liquid crystal display device displays images based on the data voltages and the common voltage applied to the liquid crystal layer;
the border area comprising:
a common electrode line connected to the common electrode and transmitting the common voltage to the common electrode; and
at least one electrostatic discharge component connected between a gate line and the common electrode line.

17. The liquid crystal display device of claim 16, wherein the at least one electrostatic discharge component is directly connected to the common electrode line.

18. The liquid crystal display device of claim 17, wherein the at least one electrostatic discharge component comprises a plurality of electrostatic discharge components located in the border area, and each gate line is connected to the common electrode line via the at least one electrostatic discharge component.

19. The liquid crystal display device of claim 18, further comprising a gate driver, wherein each gate line comprises a first end and a second end; the gate driver is connected to the first ends of the gate lines and outputs the gate signals to the gate lines;
the gate signals are transmitted from the first ends to the second ends; the electrostatic discharge components are connected to the second ends of the gate lines.

20. The liquid crystal display device of claim 19, further comprising a common voltage generating circuit and a feedback line connected to the common voltage generating circuit and the common electrode line; wherein the common voltage generating circuit outputs the common voltage to the common electrode via the common electrode line; the feedback line is located on the border area adjacent to the second ends of the gate lines, the feedback line receives a feedback common voltage from the common electrode line and outputs the feedback common voltage to the common voltage generating circuit; the common voltage generating circuit adjusts the common voltage output to the common electrode line based on the feedback common voltage.
